(19) United States
(12) Patent Application Publication
(10) Pub. No.: US 2017/0278134 A1
(43) Pub. Date: Sep. 28, 2017

(54) SYSTEM AND METHOD OF MONITORING USER INTERACTION WITH UNSTRUCTURED DATA

(71) Applicant: JCS CONSULTING GROUP, INC., Del Mar, CA (US)

(72) Inventor: Gian Carlo Saggese, Del Mar, CA (US)

(21) Appl. No.: 15/462,705

(22) Filed: Mar. 17, 2017

Related U.S. Application Data
(60) Provisional application No. 62/313,983, filed on Mar. 28, 2016.

(51) Int. Cl. G06Q 30/02; G06F 17/30

(52) U.S. Cl. CPC G06Q 30/0255; G06Q 30/0201; G06F 17/30722

(57) ABSTRACT

A method and apparatus of monitoring interaction with unstructured data. The method may include receiving, from a content generator, generated content, tagging content with one or more tags to associate generated content with other content, associating content with the content generator, extracting marketing information from received generated content based on the one or more tags, and targeting the associated content generator with marketing information based on extracted marketing information.

### RELATED APPLICATIONS

This application claims the benefit of Provisional Application No. 62/313,983, filed on Mar. 28, 2016, and the contents of the aforementioned application are incorporated herein by reference in their entirety

### BACKGROUND

Related art web-based lead monitoring, customer acquisition systems, and data gathering systems often rely on monitoring user interactions with specific, well-defined web pages (e.g., Uniform Resource Locators (URLs)) and/or a named content items (e.g., a product data sheet). Other related art methods have the customer implicitly answer specific questions regarding the products the user is interested in, or complete some kind of specific questionnaire. When the questions are answered or the questionnaires are completed, sales and marketing systems are triggered and customer acquisition or support personnel respond with specific, appropriate sales activities, literature, and information in order to close the sale or resolve the customer's support request. Some related art systems track a user's path through a site and use algorithms to “connect the dots” of the pages and content visited and questions answered in order to reach conclusions about products the user may be interested in. A key component of all of these related art methods is that the data points gathered from the potential customer are either pre-defined and/or static and are well-known and well-controlled by the vendor. The content used by vendors to determine product interest is almost always static (or slow to change), predictable and structured and created by the vendor.

### SUMMARY

With the introduction of user generated content online such as blogs, discussion groups, videos, polls, threaded discussions, interactions with Internet of Things devices (“IoT”) (such as smart locks, Bluetooth trackers, smart home retrofit devices (e.g., switched, outlets, etc.), smart appliances, and any other devices that might be apparent to a person of ordinary skill in the art),the vast majority of content created on the web today may be unpredictable, highly dynamic, and unstructured. A URL or named content item often may not have any relation to the content that potential customers interact with. Further, vendors may not have significant ability to predict what users will create, cross link, like, discuss, re-post, or re-purpose. Although administrators may create areas within their website properties with guidelines for topics, there is often little or no control over what happens within these areas. In some cases, the most popular content may only be tangentially related to the “official” topic and is only “in” that area because that topic is the “least inappropriate” place to store the content. Community forums are a great example of user generated content that has no predictable organization or naming nomenclature.

Example implementations of the present application may allow a system having a series of components that can filter, process and learn from unpredictable, unstructured, dynamic content created by user. Such a system may apply a series of rules in order to correctly “place” content into one or more groups. The groups themselves may become predictable and well-defined, allowing the vendor to extract meaning and take action from the unstructured content as though it were structured.

Further, example implementations of the present system may allow the vendor to dynamically “observe” the user generated content through a structured “lens” (e.g., group) and create new “lenses” (e.g., groups) in response to new, unanticipated user behavior and content developed on the site.

Aspects of example implementations of the present application may include a method of monitoring interaction with unstructured data. The method may include receiving, from a content generator, generated content, tagging content with one or more tags to associate generated content with other content, associating content with the content generator, extracting marketing information from received generated content based on the one or more tags, and targeting the associated content generator with marketing information based on extracted marketing information.

Additional aspects of example implementations of the present application may include a server device for monitoring user interaction with unstructured data. The server device may include a memory; and a processor. The processor may be configured to receive content generated by a content generator, tag content with one or more tags to associate generated content with other content, associate content with the content generator, extract marketing information from received generated content based on the one or more tags; and target the associated content generator with marketing information based on extracted marketing information.

Further aspects of example implementations of the present application may include a non-transitory computer readable medium having stored therein a program for making a computer execute a method of monitoring with unstructured data. The method may include receiving, from a content generator, generated content, tagging content with one or more tags to associate generated content with other content, associating content with the content generator, extracting marketing information from received generated content based on the one or more tags, and targeting the associated content generator with marketing information based on extracted marketing information.

Still further aspects of example implementations of the present application may include a server device. The server device may include a memory, and means for receiving content generated by a content generator, means for tagging content with one or more tags to associate generated content with other content, means for associating content with the content generator, means for extracting marketing information from received generated content based on the one or more tags, and means for targeting the associated content generator with marketing information based on extracted marketing information.

### BRIEF DESCRIPTION OF THE DRAWINGS

FIG. 1 illustrates an example system of monitoring interactions with unstructured data according to an example implementation of the present application.

FIG. 2 illustrates an example process of monitoring interactions with unstructured data according to an example implementation of the present application.

FIG. 3 shows an example environment suitable for some example implementations of the present application.

FIG. 4 provides a block diagram illustrating an example computing device or system that may be used in connection with various embodiments described herein.

### DETAILED DESCRIPTION

The subject matter described herein is taught by way of example implementations. Various details have been omitted for the sake of clarity and to avoid obscuring the subject matter. Examples shown below are directed to structures and functions requesting and obtaining response to needs.

Example implementations of the present application may provide an ability to extract aspects from one or more of content by one or more of a user or an IoT device. In some example implementations, the extracted aspects may include one or more of:
User interest in products (e.g., user generated content talking about the products);
User interest in services (e.g., user generated content talking about the services);
User complaints about products or services (e.g., user generated content complaining about products or services);
User interaction with products or services (e.g., a user wearing work-out clothes with IoT embedded devices automatically logging how much time they spent on different equipment and how hard they worked).
Opportunities to upsell or cross-sell products or services to the user (e.g., user generated content mentioning multiple products or services together or user generated content about product deficiencies or unmet needs that could be met by different or additional products or services);
Opportunities to upsell or cross-sell products or services to the user due to interactions with IoT devices (e.g. individual IoT lights reporting when they are turned on and for how long allowing the vendor to recommend more appropriate, energy-efficient options).
Referrals to new customers (e.g., user generated content recommending product or service to other users or user generated content mentioning others who have similar requirements or unmet needs);
Opportunities to extend products in new directions (product development) (e.g., user generated content mentioning an unmet need for a product or service);
Opportunities to develop new pricing and distribution models (e.g., user generated content describing problems with pricing or inadequate distribution);
Opportunities to extend sales into new geographies or to new customer (e.g., user generated content mentioning an unmet need for a product or service in geographies or among customers);
Opportunities to take advantage of new channels.

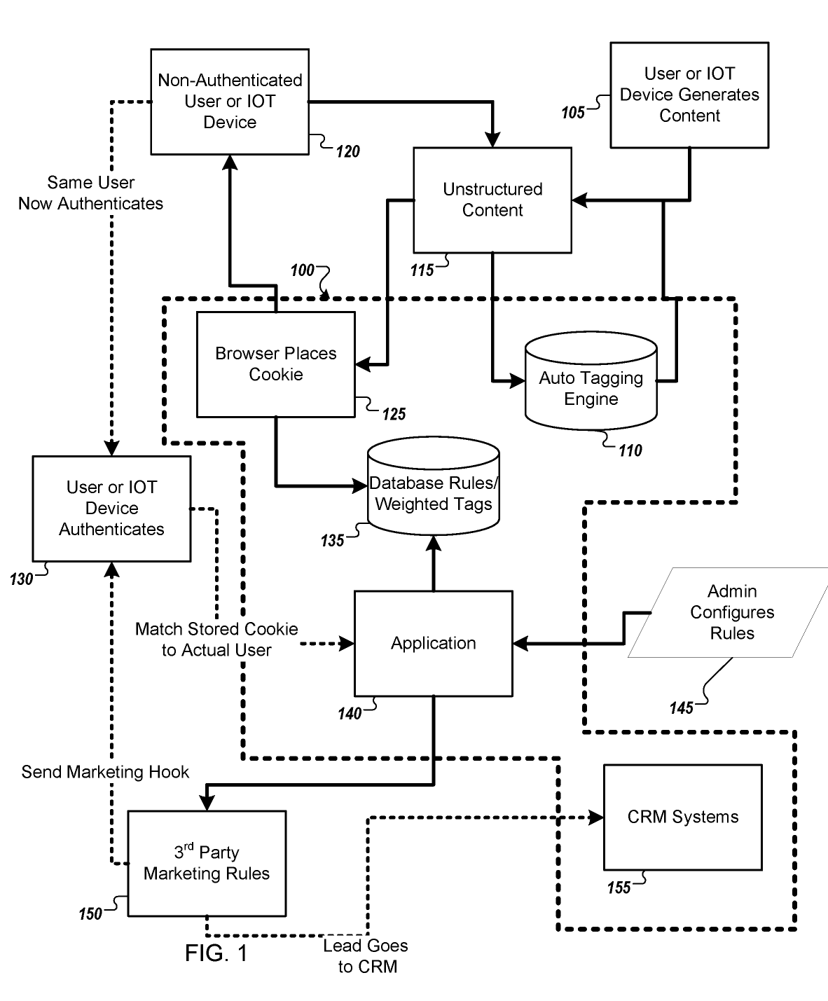

FIG. 1 illustrates data flow of an example system 100 of monitoring user or IoT device interaction with unstructured data according to an example implementation of the present application.

The system 100 includes five components: an Auto tagging mechanism or engine 110 (to establish classes of similar unstructured data); a Cookie placement mechanism 125 (e.g., a Browser to associate content with a device and/or user); a Database 135 (to store the data); Application 140 (to process the unstructured data into structured groups and to control activities); and integration with 3rd party marketing systems 155 (to extract the now-structured data and gain value)

As illustrated, a user or IoT device 105 generates unstructured content 115. The generated unstructured content may include text, writings, photos, videos, audio or any other content that could be generated by a user or IOT device. The Auto tagging engine 110 processes the unstructured content 115. Specifically, in order to effectively use unstructured content, the content needs to be grouped in a structured manner. The auto tagging engine 110 parses the Unstructured Content 115 and associates one or more tags with the Unstructured Content. In some example implementations, this may involve using content recognition techniques such as Optical character recognition, image recognition, shape recognition, semantic recognition, or any other content recognition process that might be apparent to a person of ordinary skill in the art.

In some example implementations, the auto tagging engine may use a variety of methods to determine which tags to apply to the unstructured content. For instance the auto tagging engine may utilize a manually maintained list directing it to apply a certain tag to any content that contains a certain word or phrase or the auto tagging engine may apply machine based tagging to unstructured content, to create a defined structure for the content. For example, in some example implementations, machine based tagging may be used by relying on natural language processing to define the tags for the content. Natural language processing is a method whereby programs examine the unstructured content looking for patterns.

The occurrence of a given pattern will cause the algorithm to assign a matching tag to the content under examination. A given piece of content may have from zero to n tags assigned where n is only limited by the number of groups the vendor is interested in. Groups can either be explicitly created by the vendor or can be dynamically created by the algorithm based on the algorithm “detecting” key factors. Key factors may include repetition (e.g., repetition within a limited set of content such as a discussion; repetition within a limited area of the site such as a sub-page structure). Pattern key factors may also include adjacency (e.g., patterns that occur closely in time to each other, patterns that occur near other patterns in the same set of content or within a limited area. Pattern key factors can also include frequency (e.g., patterns that occur over a threshold frequency, either within a limited period of time or over a great deal of time). Note that the patterns are not limited to words, phrases, or numbers. The patterns could also include any type of content including pictures, videos, audio etc. If objects can be represented by bits on a computer, it can be pattern-matched by the auto tagging mechanism.

After the auto tagging engine 110 has processed the unstructured content 115, the tags associated with the unstructured content 115 are fed to the cookie placement mechanism 125 (e.g., a browser to associate content with a device and/or user). An HTTP cookie (also called web cookie, Internet cookie, browser cookie or simply cookie) is a small piece of data sent from a website and stored in the user's web browser while the user is browsing it.

Every time the user loads the website, the browser sends the cookie back to the server to notify the server of the user's previous activity. This cookie may track a user's interaction with the tags that are placed on the unstructured content. These activities will be stored with the cookie information in a database. Cookies may always be explicitly tracked to any device interacting with the website (e.g., PC, laptop, smartphone, tablet, etc.) even if the user does not provide any specific information about them. Thus a profile of the user can be built up based on the interaction of a specific device with the website. As the user registers for more interaction with content, the cookie can be associated with the actual user in addition to being associated with the device.

If the cookie is indicative of a new user, the browser 125 may proceed to a non-authenticated user or IoT device pathway 120. As an unauthenticated user, the user can continue to interact with the unstructured content 115. Optionally, a non-authenticated user may go through an authentication process to become an authenticated user or IoT device 130. Once the user has become authenticated user or IoT device 130, the cookie associated with the content may be matched to the actual user and used by the application 140.

After the browser 125 places the cookies on a device, the database 135 may store the user's interactions with content tags, and the patterns may be “looked for” or dynamically found and the associated tags that are then associated with the content.

Application 140 may contain a rules engine 145 that may be configured by the content hosting provider (e.g., Administrator). The rules engine 145 of the application 140 may be configured to track only valuable tags assigned by the auto tagging engine 110 for customer acquisition. Different tags may be assigned different weights by the application 140, which may rank the tags in order of importance. The weighted tags can be combined into a campaign for aggregation to be passed onto the 3rd party marketing system (e.g., CRM Systems) 155. The application 140 may have configurable 3^{rd} party marketing rules 150 and data mapping to control the interaction with the 3rd party marketing systems 155.

The machine tagging system 110 may be incorporated into the application 140 and the tagging engine 110 may be taught to identify marketing valuable tags and apply this to the content by the auto tagging engine 110. Alternatively, the tagging engine 110 may “detect” patterns on the system's 100 own and “suggest” new groupings of tags.

In some example implementations, the system 100 may be configurable to interface with 3rd party marketing systems 155. Based on the configurable 3^{rd} party marketing rules 150, marketing hooks may be sent to authenticated users 130 and marketing leads for following up on may be sent to the 3^{rd} party marketing systems 155. These systems 155 can use the acquired data (e.g., leads) to define custom marketing programs such as e-mail campaigns, custom advertisement placement etc. that will complete the cycle of customer acquisition based on 3^{rd} party marketing rules 150.

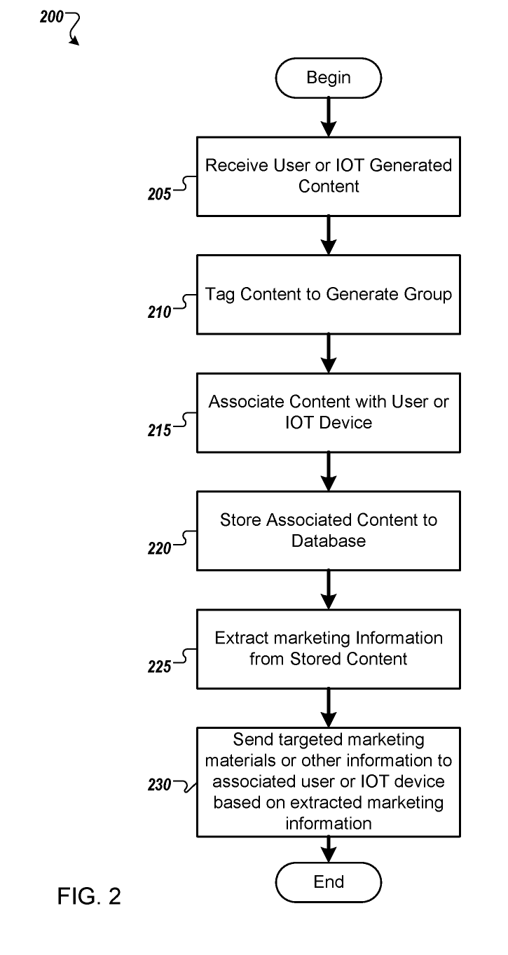

FIG. 2 illustrates an example process 200 of monitoring user interaction with unstructured data according to an example implementation of the present application. This process may be performed by a processor in a computing device such as the system 405 discussed below. In the process 200, user generated or IoT device content is received at 205. Content could be photos, audio, video, blog posts, or any other content that may be apparent to a person of ordinary skill in the art. Content could be received via website upload, email, peer-to-peer transfer or any other mechanism that may be apparent to a person of ordinary skill in the art.

After the content is received, the content is tagged to group with other similar content at 210. As discussed above, tagging can be done using machine based tagging by relying on natural language processing to define the tags for the content. In some example implementations, object or character recognition algorithms may also be applied to the content to define the tags.

After the content has been tagged, the content may be associated with a user or IoT device who has sent or transmitted the content at 215. Content may be associated with a user by first associating the content with a cookie that associates the content with a specific device from which the content is received. By tracking the usage of the specific device (with the user's consent), the device can be associated with a specific user and the content received from the device can be associated with the specific user.

The received content, the associated tags, and the association with the specific device or the specific user may all be stored to a database or other storage device at 220. The association between the content, the tags, and specific user or device may all be stored in such a way that the interconnection is maintained (e.g., the links between the tags, the content and the specific user or device are preserved during storage to allow subsequent lookup or cross-referencing).

After the associated tags, content, and association with a specific user or device are stored, marketing information may be extracted from the content at 225. For example, content tagged as related to particular products or services, or identified needs may be used to identify associated users or devices that are talking about the products, services, or needs (e.g., content talking about wanting a new computer may be used to identify consumers looking to purchase a computer; content tagged as related to cell-phones may be used to identify who is interested in a particular model, etc.).

Once the marketing information is extracted, targeted marketing materials may be sent to an associated user at 230. For example, users who have posted about needing cell phones may be targeted with advertising related to new models, sent information about upcoming sales, presented with product reviews, etc. The marketing materials may be sent by email, Short Message Service (SMS) message, app based notification, browser pop-up or other mechanism that may be apparent to a person of ordinary skill in the art. In some embodiments, the marketing information may be sent by providing information about the associated user to a 3^{rd} party marketing system for follow-up by call, in-person visit, etc. The process 200 may then end after the targeted marketing materials have been sent.

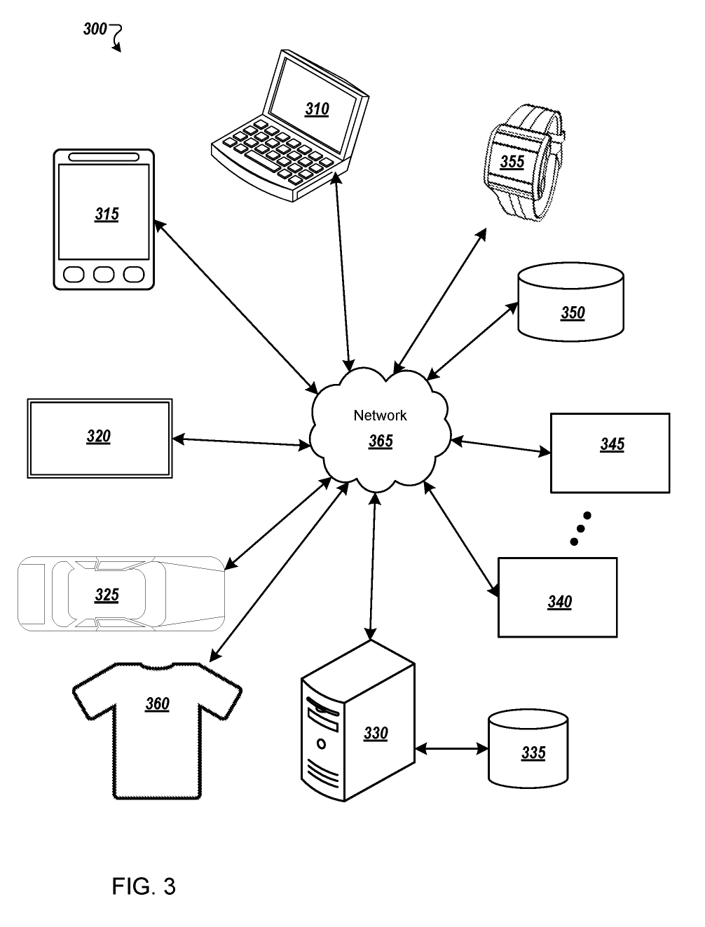

FIG. 3 shows an example environment 300 suitable for some example implementations. Environment 300 includes devices 310-355, and each is communicatively connected to at least one other device via, for example, network 365 (e.g., by wired and/or wireless connections). Some devices may be communicatively connected to one or more storage devices 335 and 350.

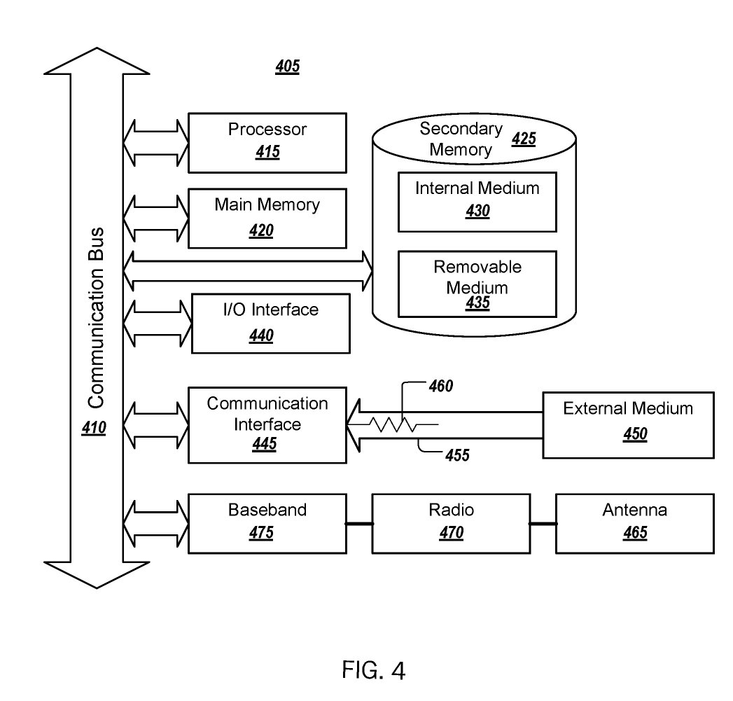

An example of one or more devices 310-360 may be a system 405 described below in FIG. 4. Devices 310-360 may include, but are not limited to, a computer 310 (e.g., a laptop computing device), a mobile device 315 (e.g., smartphone or tablet), a television 320, a device(s) or IoT device(s) associated with or embedded in a vehicle 325, a server computer 330, computing devices 340-345, storage devices 335 and 350 and wearable device(s) 355 and 360 such as watches, exercise tracking devices and others. Such wearable devices are not limited to devices worn on the wrist but could be embedded in clothes, earphones, chest measurement devices, accelerometers in shoes, eyeglass or helmet-mounted devices, such as device 360

In some implementations, devices 310-325 and 355 may be considered user devices (e.g., devices used by users to access the media platform, post content, edit content, and review marketing materials), or they may be devices that report on the environment around the user and how the user is interacting with the environment. Devices 330-350 may be devices associated with the platform to review and interact with user postings and provide distribution of posted content, and track tagged marketing information.

For example, a user (e.g., Alice) may access the social media platform, post content, and review tags received to the content using user device 310 or 315 on the social media platform supported by one or more devices 330-350. Further, another user (“recipient user”; e.g., Bob) may access and/or view Alice's posted content, comment on and reply to using user device 320, 325, or 355. Both owner and recipient user may receive push notifications regarding published content, responses, marketing materials, and other activities.

In other implementations, devices 325 and 350 may be embedded devices that interact with the media platform automatically. For example, a user (e.g., Carlo may have an electric car which he is driving a long distance. The GPS of the car is telling him of upcoming charging stations and communicates with a database when Carlo pulls off the road and charges the car at a charging station with a particular restaurant. From that point on Carlo may receive push notifications every time the GPS “sees” a charging station associated with the same restaurant.

FIG. 4 provides a block diagram illustrating an example computing device or system 405 that may be used in connection with various embodiments described herein. For example, the system 405 may be used as or in conjunction with one or more of the mechanisms or processes described above, and may represent components of processors, user system(s), and/or other devices described herein. The system 405 can be a server or any conventional personal computer, or any other processor-enabled device that is capable of wired or wireless data communication. Other computer systems and/or architectures may be also used, as will be clear to those skilled in the art.

The system 405 preferably includes one or more processors, such as processor 415. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 415. Examples of processors which may be used with system 405 include, without limitation, the Pentium® processor, Core i7® processor, and Xeon® processor, all of which are available from Intel Corporation of Santa Clara, Calif.

The processor 415 is preferably connected to a communication bus 410. The communication bus 410 may include a data channel for facilitating information transfer between storage and other peripheral components of the system 410. The communication bus 410 further may provide a set of signals used for communication with the processor 415, including a data bus, address bus, and control bus (not shown). The communication bus 410 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 405 preferably includes a main memory 420 and may also include a secondary memory 425. The main memory 420 provides storage of instructions and data for programs executing on the processor 415, such as one or more of the functions and/or modules discussed above. It should be understood that programs stored in the memory and executed by processor 415 may be written and/or compiled according to any suitable language, including without limitation C/C++, Java, JavaScript, Pearl, Visual Basic, .NET, and the like. The main memory 420 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 425 may optionally include an internal memory 430 and/or a removable medium 435, for example a floppy disk drive, a magnetic tape drive, a compact disc (CD) drive, a digital versatile disc (DVD) drive, other optical drive, a flash memory drive, etc. The removable medium 435 is read from and/or written to in a well-known manner. Removable storage medium 435 may be, for example, a floppy disk, magnetic tape, CD, DVD, SD card, etc.

The removable storage medium 435 is a non-transitory computer-readable medium having stored thereon computer executable code (i.e., software) and/or data. The computer software or data stored on the removable storage medium 435 is read into the system 405 for execution by the processor 415.

In alternative embodiments, secondary memory 425 may include other similar means for allowing computer programs or other data or instructions to be loaded into the system 405. Such means may include, for example, an external storage medium 450 and an interface 445. Examples of external storage medium 450 may include an external hard disk drive or an external optical drive, or and external magneto-optical drive.

Other examples of secondary memory 425 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 435 and communication interface 445, which allow software and data to be transferred from an external medium 450 to the system 405.

System 405 may include a communication interface 445. The communication interface 445 allows software and data to be transferred between system 405 and external devices (e.g. printers), networks, or information sources. For example, computer software or executable code may be transferred to system 405 from a network server via communication interface 445. Examples of communication interface 445 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 405 with a network or another computing device.

Communication interface 445 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 445 are generally in the form of electrical communication signals 460. These signals 460 are preferably provided to communication interface 445 via a communication channel 455. In one embodiment, the communication channel 455 may be a wired or wireless network, or any variety of other communication links. Communication channel 455 carries signals 460 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 420 and/or the secondary memory 425. Computer programs can also be received via communication interface 445 and stored in the main memory 420 and/or the secondary memory 425. Such computer programs, when executed, enable the system 405 to perform the various functions of the present invention as previously described.

In this description, the term “computer readable medium” is used to refer to any non-transitory computer readable storage media used to provide computer executable code (e.g., software and computer programs) to the system 405. Examples of these media include main memory 420, secondary memory 425 (including internal memory 430, removable medium 435, and external storage medium 450), and any peripheral device communicatively coupled with communication interface 445 (including a network information server or other network device). These non-transitory computer readable mediums are means for providing executable code, programming instructions, and software to the system 405.

In an embodiment that is implemented using software, the software may be stored on a computer readable medium and loaded into the system 405 by way of removable medium 435, I/O interface 440, or communication interface 445. In such an embodiment, the software is loaded into the system 405 in the form of electrical communication signals 460. The software, when executed by the processor 415, preferably causes the processor 415 to perform the inventive features and functions previously described herein.

In an embodiment, I/O interface 440 provides an interface between one or more components of system 405 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

The system 405 also includes optional wireless communication components that facilitate wireless communication over a voice network and/or over a data network. The wireless communication components comprise an antenna system 465, a radio system 470, and a baseband system 475. In the system 405, radio frequency (RF) signals are transmitted and received over the air by the antenna system 465 under the management of the radio system 470.

In one embodiment, the antenna system 465 may comprise one or more antennae and one or more multiplexors (not shown) that perform a switching function to provide the antenna system 465 with transmit and receive signal paths. In the receive path, received RF signals can be coupled from a multiplexor to a low noise amplifier (not shown) that amplifies the received RF signal and sends the amplified signal to the radio system 470.

In alternative embodiments, the radio system 470 may comprise one or more radios that are configured to communicate over various frequencies. In one embodiment, the radio system 470 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 470 to the baseband system 475.

If the received signal contains audio information, then baseband system 475 decodes the signal and converts it to an analog signal. Then the signal is amplified and sent to a speaker. The baseband system 475 also receives analog audio signals from a microphone. These analog audio signals are converted to digital signals and encoded by the baseband system 475. The baseband system 475 also codes the digital signals for transmission and generates a baseband transmit audio signal that is routed to the modulator portion of the radio system 470. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 465 where the signal is switched to the antenna port for transmission.

The baseband system 475 is also communicatively coupled with the processor 415. The central processing unit 415 has access to data storage areas 420 and 425. The central processing unit 415 is preferably configured to execute instructions (i.e., computer programs or software) that can be stored in the memory 420 or the secondary memory 425. Computer programs can also be received from the baseband processor 465 and stored in the data storage area 420 or in secondary memory 425, or executed upon receipt. Such computer programs, when executed, enable the system 405 to perform the various functions of the present invention as previously described. For example, data storage areas 420 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit, or step is for ease of description. Specific functions or steps can be moved from one module, block, or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters, or with other or different elements or matters not described. It will be appreciated by those familiar with this field that changes may be made in these example implementations without departing from the subject matter described herein as defined in the appended claims and their equivalents. Additionally, examples of facilities, maps, and media information types have been provided merely for explanatory purposes and implementations of the present application are not limited to these examples.

We claim:

1. A server device for monitoring interaction with unstructured data comprising:
a memory; and
a processor configured to:
receive generated content generated by a content generator;
tag content with one or more tags to associate generated content with other content;
associate content with the content generator;
extract marketing information from received generated content based on the one or more tags; and
target the content generator with marketing information based on extracted marketing information.

2. The server apparatus according to claim 1, wherein the processor is further configured to:
automatically tag content based on machine based tagging using natural language processing.

3. The server apparatus according to claim 1 wherein the processor is further configured to:
associate content with the content generator by placing a cookie on a device associated with the content generator and tracking activity by the content generator.

4. The server apparatus according to claim 1, wherein the processor is further configured to assign weight tags associated with content based on one or more rules provided by an administrator.

5. The server apparatus according to claim 1, wherein the processor is further configured to target associated content generators with marketing information by sending one or more of: advertising, product reviews, service reviews, discount announcements, coupons, and sales information to the content generator based on the extracted marketing information.

6. The server apparatus according to claim 1, wherein the content generator is a user.

7. The server apparatus according to claim 1, wherein the content generator is an IoT device.

8. A method of monitoring interaction with unstructured data, the method comprising:
receiving, from a content generator, generated content;
tagging content with one or more tags to associate generated content with other content;
associating content with the content generator;
extracting marketing information from received generated content based on the one or more tags; and
targeting the associated content generator with marketing information based on extracted marketing information.

9. The method according to claim 8, further comprising:
automatically tagging content based on machine based tagging using natural language processing.

10. The method according to claim 8, further comprising:
associating content with the content generator by placing a cookie on a device associated with the content generator and tracking activity by the content generator.

11. The method according to claim 8, further comprising assigning weight tags associated with content based on one or more rules provided by an administrator.

12. The method according to claim 8, further comprising targeting associated content generators with marketing information by sending one or more of:
advertising, product reviews, service reviews, discount announcements, coupons, and sales information to the content generator based on the extracted marketing information.

13. The method according to claim 8, wherein the content generator is a user.

14. The method according to claim 8, wherein the content generator is an IoT device.

15. A non-transitory computer readable medium having stored therein a program for making a computer execute a method of monitoring with unstructured data, the method comprising:
receiving, from a content generator, generated content;
tagging content with one or more tags to associate generated content with other content;
associating content with the content generator;
extracting marketing information from received generated content based on the one or more tags; and
targeting the associated content generator with marketing information based on extracted marketing information.

16. The non-transitory computer readable medium according to claim 15, wherein the method comprises:
automatically tagging content based on machine based tagging using natural language processing.

17. The non-transitory computer readable medium according to claim 15, wherein the method comprises:
associating content with the content generator by placing a cookie on a device associated with the content generator and tracking activity by the content generator.

18. The non-transitory computer readable medium according to claim 15, wherein the method comprises assigning weight tags associated with content based on one or more rules provided by an administrator.

19. The non-transitory computer readable medium according to claim 15, wherein the method comprises: targeting associated content generators with marketing information by sending one or more of: advertising, product reviews, service reviews, discount announcements, coupons, and sales information to the content generator based on the extracted marketing information.

20. The non-transitory computer readable medium according to claim 15, wherein the content generator is a user.

21. The non-transitory computer readable medium according to claim 15, wherein the content generator is an IoT device.
